(19) United States
(12) Patent Application Publication
(10) Pub. No.: US 2026/0216730 A1
(43) Pub. Date: Jul. 30, 2026

(54) FLUIDIC UNIT FOR DISCRETE ELEMENT TRAPPING

(71) Applicant: UNIVERSITÉ DE LIÈGE, Liège (BE)

(72) Inventors: Ali Gholizadeh, Angleur (BE); Gabriel Mazzucchelli, Liège (BE); Christopher Kune, Liège (BE); Tristan Gilet, Boncelles (BE)

(73) Assignee: UNIVERSITÉ DE LIÈGE, Liège (BE)

(21) Appl. No.: 19/159,017

(22) PCT Filed: Feb. 23, 2024
(86) PCT No.: PCT/EP2024/054643

§ 371 Date: Aug. 22, 2025

(30) Foreign Application Priority Data
Feb. 24, 2023 (EP) 23158623.1

(51) Int. Cl. B01L 3/00

(52) U.S. Cl. CPC B01L 3/502761; B01L 3/502715; B01L 2200/027; B01L 2200/0605; B01L 2200/0668; B01L 2200/0689; B01L 2300/042; B01L 2300/0829; B01L 2300/123; B01L 2400/06

(57) ABSTRACT

A fluidic unit, preferably microfluidic, for trapping a discrete element in a liquid sample. The fluidic unit includes a well for receiving a volume of a liquid, the well including the discrete element; a well output conduit; a metering chamber in fluid communication with the well through the well output conduit, for metering a liquid sample of the volume of the liquid received from the well; and an obstructable waste output conduit for evacuating an excess portion of the volume of the liquid from the metering chamber.

### TECHNICAL AREA

According to a first aspect, the invention relates to a fluidic unit, preferably a microfluidic unit, for trapping a discrete element in a liquid sample. According to a second aspect, the invention relates to a bar and a sealing member for forming the fluidic unit according to the invention. According to third aspect, the invention relates to a multi-well plate comprising a plurality of the fluidic units. According to a fourth aspect, the invention relates to a method for trapping a discrete element in a liquid sample with the fluidic unit or multi-well plate of the invention.

### PRIOR ART

Sample preparation for highly-sensitive analytical methods or experiments require the precise manipulation of small volumes of liquids (e.g., smaller than 1 microliter and preferably smaller than 200 nanoliters) and small elements whose density is different from the liquid in which they are immersed (e.g., cells, small tissues, or particles). For example, a precise manipulation is needed for trapping cells and minimizing the dilution of analytes that they release during sample preparation for single-cell proteomics. Hence, there is a trend to use fluidic devices, and preferably microfluidic devices which enable the manipulation of volumes below 1 microliter. By microfluidic devices is meant devices with microchannels and/or microcavities, with at least one dimension in the micrometer range.

US2003/0224531 A1 describes a microanalytical device comprising a well plate with an integrated microfluidic system containing processing compartments such as microcavities, microchannels and the like, that are in fluid communication with electrospray emitters.

WO2018099922 describes fluidic devices, especially microfluidic devices, for aliquoting and pairwise combinatorial mixing of a first set of liquids with a second set of liquids. The device architecture is designed to move the liquids in a first direction, from a reservoir to aliquot chambers, when the liquids are exposed to a first directional force field.

A drawback of the devices of US2003/0224531 A1 and WO2018/099922A1 is that they do not allow for trapping discrete elements such as cells in a controlled volume of a liquid and for significantly decreasing the dilution of the discrete elements and/or released analytes in the liquid, i.e. by an order of magnitude or more.

The aim of the invention is to provide a device that enables the trapping of a discrete element immersed in a volume of a liquid and drastically reducing the dilution of this discrete element in the liquid, while not significantly modifying the concentration of solutes other than the discrete element. The discrete element is trapped in a metered sample from the volume of the liquid. Preferably, the metered sample has a volume of less than 1 microliter.

### SUMMARY OF THE INVENTION

According to a first aspect, one of the objects of the present invention is to provide a fluidic unit for trapping a discrete element in a liquid sample having a volume inferior to 1 microliter. The fluidic unit comprises a fluidic circuit comprising:
a well for receiving a volume of a liquid comprising the discrete element;
a well output conduit;
a metering chamber in fluid communication with the well through said well output conduit, for metering a liquid sample of the volume of the liquid received from the well;
an obstructable waste output conduit for evacuating an excess portion of the volume of the liquid from the metering chamber.

In the invention, the waste output conduit can be obstructed such that no liquid can pass through. When the waste output conduit is obstructed, the liquid can flow from the well to the metering chamber in response to the application of a first force field F1 but is prevented from exiting from the fluidic unit via the waste output conduit. As a result, the liquid is prevented from carrying the discrete element out of the fluidic unit via the waste output conduit as in the devices of the prior art. Instead, the discrete element remains in the metering chamber and/or migrates to the metering chamber in response to the effect of the first force field F1. This enables the trapping of the discrete element in the submicroliter liquid sample, thereby drastically reducing the dilution of this discrete element in the liquid without modifying the concentration of solutes other than the discrete element.

Preferably, the fluidic unit comprises waste output conduit obstruction means able to be in closed and opened configurations for preventing or allowing the liquid to pass through the waste output conduit, respectively.

The fluidic unit is preferably configured such that, in response to an application of a first force field F1:
when the waste output conduit obstruction means is in the closed configuration:
   the liquid is able to pass from the well to the metering chamber through the well output conduit, and
   the discrete element is able to pass from said well to said metering chamber through the well output conduit,
upon switching the waste output conduit obstruction means from the closed to the opened configuration:
   the liquid sample and the discrete element are prevented from exiting the metering chamber through the waste output conduit, and
   the excess portion is able to exit from said metering chamber through the waste output conduit.

Thanks to the waste output conduit obstruction means, it is possible to at least temporarily close the waste output conduit of the fluidic unit of the invention. When the waste output conduit obstruction means is obstructing the waste output conduit, the liquid can flow in response to the effect of the first force field F1 from the well to the metering chamber but is prevented from exiting from the fluidic unit via the waste output conduit. As a result, the liquid is prevented from carrying the discrete element out of the fluidic unit via the waste output conduit as in the devices of the prior art. Instead, the discrete element remains in the metering chamber and/or migrates to the metering chamber in response to the effect of the first force field F1.

Preferably, in the fluidic unit of the invention:
the fluidic circuit extends along an axis X2 of the fluidic unit,
the well extends along the axis X2 and in the direction of increasing X2 from a lower opening to an upper opening of the well,
the well output conduit extends along the axis X2 and in the direction of increasing X2 from a lower opening of the well output conduit to the lower opening of the well,
the metering chamber extends along the axis X2 and in the direction of increasing X2 from a lower end to an upper end of the metering chamber, the upper end of the metering chamber being in fluid communication with the well output conduit through the lower opening of the well output conduit,
the waste output conduit extends along the axis X2 and in the direction of increasing X2 from a lower opening to an upper opening of the waste output conduit in fluid communication with the metering chamber, the upper opening of the waste output conduit being located between the upper end of the metering chamber and the lower opening of the well output conduit along the axis X2.

For example, the upper end of the metering chamber is an opening for receiving the liquid in the metering chamber.

Preferably, the fluidic unit comprises a metering output conduit extending at least partially along the axis X2 and in fluid communication with the metering chamber, wherein the metering output conduit extends beyond the well output conduit in the direction of increasing X2.

In other words, the fluidic unit comprises a metering output conduit extending along the axis X2 and in the direction of increasing X2 from a lower opening of the metering output conduit in fluidic communication with the upper end of the metering chamber to an upper opening of the metering output conduit, wherein the lower opening of the metering output conduit is located higher than the lower opening of the well output conduit along the axis X2.

This allows for evacuating the sample from the metering chamber by applying a second force field F2 opposed to the first force field F1 on the fluidic unit, while avoiding a backflow of the liquid towards the well.

Preferably, the lower opening of the metering output conduit is separated from the lower opening of the well output conduit by a distance measured along the axis X2 strictly greater than Oum, preferably of at least 1 μm.

Preferably, the well has a volume comprised between 1 and 100 microliters (μl), preferably between 5 and 20 μl.

Preferably, the metering chamber has a volume comprised between 1 nanoliter (nl) and 1 microliter (μl), preferably between 10 nl and 200 nl.

Preferably, the mixing chamber has a volume comprised between 10 nanoliter (nl) and 10 microliters (μl), preferably between 100 nl and 1 μl.

In a preferred embodiment:
a cross-sectional area of the metering output conduit is measured in a plane normal to a longitudinal axis of the metering output conduit,
a cross-sectional area of the well output conduit is measured in a plane normal to a longitudinal axis of the well output conduit, and the cross-sectional area of the metering output conduit at its lower opening is greater than the cross-sectional area of the well output conduit at the lower opening of the well output conduit.

This avoids a backflow of the liquid from the metering chamber towards the well when evacuating the sample from the metering chamber by applying the second force field F2 on the fluidic unit.

Preferably, a ratio of the cross-sectional area of the metering output conduit at a level of the lower opening of the metering output conduit to the cross-sectional area of the well output conduit at a level of the lower opening of the well output conduit is greater than 1, preferably greater than 5, more preferably greater than 20.

Preferably, the cross-sectional area of the metering output conduit substantially decreases from the lower opening to the upper opening of the metering output conduit.

This favours sample flow from the metering chamber to the mixing chamber and not to the well.

Preferably, the fluidic unit extends along the axis X2 and in the direction of increasing X2 from a lower surface to an upper surface of the fluidic unit, and wherein:
the well opens on the upper surface of the fluidic unit through the upper opening of the well,
the waste output conduit is openable on the lower surface of the fluidic unit through the lower opening of the waste output conduit.

Preferably, the lower opening of the waste output conduit and the upper opening of the well are located relative to each other such that a projection of the lower opening of the waste output conduit along the axis X2 is entirely comprised in the upper opening of the well.

This allows for stacking two fluidic units on top of each other such that the liquid flowing out of the lower opening of the waste output conduit of one of the two fluidic units is received in the well of the other one of the two fluidic units.

Preferably, the fluidic unit is configured such that a projection of a circumference of the lower opening of the waste output conduit along the axis X2 is separated from a circumference of the upper opening of the well by a distance measured in a direction orthogonal to the axis X2 comprised between 0.5 and 2.5 mm, preferably between 1.2 to 1.8 mm.

Preferably, the lower opening of the waste output conduit is located centrally with respect to the upper opening of the well. Preferably, it is located within a distance from the upper opening of the well of from about 0.5 mm to about 2.5 mm, preferably of from about 1.2 mm to about 1.8 mm, said distance being in a direction orthogonal to X1.

In an example, the fluidic unit is configured such that, when the waste output conduit obstruction means is in the closed configuration, i.e., obstructing the waste output conduit, the liquid passing from the well to the metering chamber can reach a hydrostatic state. However, it is not necessary that the liquid reaches a hydrostatic state in the metering chamber for trapping the discrete element in the metering chamber. Indeed, the liquid may flow sufficiently slowly in the metering chamber for the discrete element to remain trapped in the metering chamber by migrating towards the bottom of the metering chamber in response to the application of the first force field F1.

For example, the fluidic unit according to the invention is configured such that, if the liquid flowing from the well to the metering chamber via the well output conduit has carried the discrete element from the well to the metering chamber therewith, the discrete element remains in the metering chamber and migrates towards a bottom of the metering chamber in response to the effect of the first force field F1.

In another example, the fluidic unit according to the invention is configured such that, if the liquid flowing from the well to the metering chamber via the well output conduit has not carried the discrete element from the well to the metering chamber therewith, the discrete element can migrate in the liquid, from the well via the well output conduit and to the metering chamber, preferably to the bottom of the metering chamber. Preferably, the fluidic unit is configured such that the discrete element can decant in the liquid in response to the application of the first force field F1 and reach the bottom of the metering chamber.

Once the discrete element is trapped in the metering chamber, switching the waste output conduit obstruction means from the closed to the opened configuration allows the liquid to flow from the metering chamber through the waste output conduit and out of the fluidic unit. The liquid sample containing the discrete element remains trapped in the metering chamber while the excess portion of the liquid leaves the metering chamber via the waste output conduit. In this way, the fluidic unit can trap the discrete element contained in the liquid sample, and the discrete element can then be used in experiments.

Compared with the device of the prior art, the fluidic unit according to the invention allows for trapping one or more discrete elements initially diluted in a liquid of relatively high volume in a liquid sample of relatively low volume, such that a ratio between the initial volume of the liquid and the final volume of the liquid sample is greater than 10. Moreover, molecules other than the one or more discrete elements are usually dissolved in the liquid (e.g., the PBS buffer for living cells). With the device of the invention, the concentration of these molecules is not affected by the metering and trapping. The concentration of these molecules is thus the same in the volume of the liquid as in the liquid sample. In other words, the fluidic unit of the invention allows for trapping and reducing the dilution of the one or more discrete elements in the liquid while keeping a concentration of other molecules constant in the liquid. This allows for a better control of the concentration of other molecules reacting with the one or more discrete elements when conducting experiments. This is advantageous in comparison with reducing the dilution of discrete elements that are living cells by evaporating the liquid, for example. In the latter case, the concentration of the dissolved molecules would increase to the point where it would become lethal to the living cells.

In other words, the fluidic unit according to the invention allows for reducing the dilution of a cell in a liquid without modifying the composition of the liquid surrounding the cell.

Preferably, the fluidic unit according to the invention is a microfluidic unit.

In an example, the fluidic unit is embedded in a lab-on-disk.

In an example, the well of the fluidic unit is a well of a multi-well plate. The well of the fluidic unit according to the invention is typically configured for receiving the volume of the liquid to be processed in the fluidic unit. Typically, the volume of the liquid is small to avoid excessive dilution of the discrete element in the liquid. However, the volume of the liquid is usually greater than 1 microliter (μL) due to the difficulty of manipulating smaller quantities of liquid. An advantage of the fluidic unit according to the invention is the possibility of reducing the dilution of the discrete element in the liquid i.e. by an order of magnitude or more, without impacting the concentration of other elements dissolved in the liquid surrounding the discrete element. This is achieved by trapping the discrete element in the liquid sample of a volume much smaller than the volume of the liquid initially received in the well.

The well of the fluidic unit is preferably configured for receiving the volume of the liquid from a pipette that is operated manually or automatically. Preferably, the well is configured for receiving the volume of the liquid being of 1 microliter or more, preferably between 2 and 10 microliters. Preferably, the fluidic unit is configured such that a ratio of the volume of the well to the volume of the liquid sample metered by the metering chamber is greater than 1, preferably greater than 5, preferably greater than 10, preferably comprised between 2 and 50, preferably comprised between 4 and 20.

In an example, the discrete element is immersed in the volume of the liquid received in the well or is carried by it.

Preferably, the fluidic unit is configured for trapping the discrete element having a volume less than 1 microliter. Preferably, the discrete element has dimensions comprised between 1 μm and 500 μm, preferably between 5 μm and 30 μm. Dimensions comprised between 5 μm and 30 μm typically correspond to a size of an eucaryotic cell.

Preferably, the fluidic unit is configured such that, in response to the application of the first force field F1, the discrete element can migrate in the liquid towards a bottom of the metering chamber. In the present disclosure, the bottom of the metering chamber refers to a location in the metering chamber that is an extremal and downstream portion of the metering chamber along the direction of the first force F1 field in the metering chamber. In this way, for example a discrete element having a higher mass density than the liquid can migrate in the liquid towards the bottom of the metering chamber in response to the application of the first force field F1.

The metering chamber of the fluidic unit according to the invention is configured for metering a liquid sample out of the volume of the liquid received from the well. In other words, it is configured for separating a portion of the volume of the liquid herein referred to as the liquid sample from another portion of the volume of the liquid herein referred to as the excess portion, by preventing the liquid sample to flow out of the metering chamber through the waste output conduit. Preferably, the metering chamber is configured for metering a liquid sample having a volume inferior to 1 microliter. Preferably, the metering chamber is configured for metering a liquid sample having a volume comprised between 1 nanoliter and 1 microliter, preferably between 20 nanoliters and 200 nanoliters.

For example, the volume of the liquid sample can be predetermined using simulations taking into account the properties of the liquid and the shape of the metering chamber.

In an example wherein the discrete element is a cell, the fluidic unit can advantageously be used for trapping the cell in a first liquid sample and mixing the first liquid sample with one or more subsequent liquid samples comprising reagent for lysis the cell.

Preferably, the metering chamber is an overflow metering chamber.

The first force field F1 applied to the fluidic circuit drives the flow of the liquid and the movement or migration of the discrete element. The first force field F1 can be a gravity force field, but is preferably a centrifugal force field. In such case, the discrete element preferably has a higher mass density than the liquid. The first force field F1 can also be a magnetic force field, an electrostatic force field, an electrophoretic force field, a dielectrophoretic force field, or other inertial force field such as Euler, Coriolis, or vibration force field. It can also be an acoustic force field.

Preferably, the well output conduit comprises a capillary valve for letting the liquid flow from the well to the metering chamber in response to the application of the first force field F1.

The waste output conduit of the fluidic unit is configured for evacuating the excess portion out of the metering chamber, and preferably out of the fluidic unit. The waste output conduit is typically in fluid communication with an exterior of the fluidic unit or with a waste reservoir configured for receiving one or more excess portions. The waste reservoir may for example be comprised in the fluidic unit. Alternatively to a waste reservoir or in addition to a waste reservoir, the waste output conduit may be in fluid communication with a waste collection container.

Preferably, the waste output conduit comprises a lower opening comprised in a lower surface of the fluidic unit. This allows easy access for closing the waste output conduit with external means, for example.

Preferably, the waste output conduit obstruction means is selected among:
a valve for closing and opening the waste output conduit;
a tape for removably sticking to the lower surface of the fluidic unit to obstruct the lower opening of the waste output conduit;
a plug for removably obstructing the lower opening of the waste output conduit, wherein the plug is preferably for inserting in the lower opening of the waste output conduit ;
a dead-end of the waste output conduit, and the waste output conduit is openable by piercing or drilling the fluidic unit through the dead-end, or
a dissolvable membrane for obstructing the lower opening of the waste output conduit and for dissolving upon an application of a solvent on it.

In the case of the dissolvable membrane, such membrane could be dissolved by letting a solvent enter in contact with the membrane upon dissolving it and opening the waste output conduit. An example of dissolvable membrane is described in D. J. Kinahan et al., Lab Chip 13, 2014.

Preferably, the waste output conduit obstruction means is a dead-end of the waste output conduit, and the waste output conduit is openable by piercing or drilling the fluidic unit through the dead-end. For example, the lower opening of the waste output conduit can be closed by default when manufacturing the fluidic unit, and openable by piercing to allow the liquid to exit the metering chamber and the fluidic unit via the waste output conduit.

In a preferred embodiment of the fluidic unit, the fluidic circuit comprises:
a metering output conduit;
a mixing chamber in fluid communication with the metering chamber through said metering output conduit, for mixing several liquid samples coming from the metering chamber.

In this case, the fluidic unit may be configured such that the liquid sample comprising the discrete element is able to pass from said metering chamber to said mixing chamber through the metering output conduit in response to an application of a second force field F2 different from the first force field F1.

The presence of a mixing chamber in the fluidic unit allows for sequentially metering and mixing several liquid samples using a same fluidic unit. In particular, different liquid samples can be supplied successively to the mixing chamber after having been metered.

For example, different liquid samples, each comprising a plurality of discrete elements, can be successively metered and supplied to the mixing chamber. This allows to capture two or more discrete elements from different populations and to supply them to the mixing chamber at different times, which would allow to investigate cell-cell interactions in a confined and controlled environment.

In another example, one or more liquid samples each comprising a respective discrete element can be brought and mixed in the mixing chamber with one or more liquid samples not comprising discrete elements.

In yet another example, the fluidic unit comprising the mixing chamber allows for trapping a cell in a first liquid sample and transferring it to the mixing chamber, then metering a second liquid sample out of a second volume of a second liquid to mix with the first liquid sample.

In a preferred embodiment, the waste output conduit obstruction means in the fluidic unit comprising the mixing chamber is configured for preventing the liquid from passing through the waste output conduit in response to the application of the first and second force fields F1, F2. In this way, the excess portion evacuated from the metering chamber in response to the application of the first force field F1 is prevented from returning in the metering chamber via the waste output conduit in response to the application of the second force field F2.

Preferably, the fluidic unit is configured for preventing liquid from exiting from said metering chamber through the waste output conduit in response to the application of the second force field F2, even if the waste output conduit obstruction means are in the opened configuration. In this way, the waste output conduit obstruction means do not need to be set in the closed configuration again when transferring the metered liquid sample from the metering chamber to the mixing chamber.

Preferably, in the fluidic unit according to the invention:
the mixing chamber extends along the axis X2 and in the direction of increasing X2 from a lower end to an upper end of the mixing chamber,
the metering output conduit is in fluidic communication with the mixing chamber through the upper opening of the metering output conduit,
the upper opening of the metering output conduit is located below the upper end of the mixing chamber along the axis X2, preferably separated from the upper end of the mixing chamber by a distance measured along the axis X2 of at least 1 μm,
the upper opening of the metering output conduit is located above the lower end of the mixing chamber along the axis X2, preferably separated from the lower end of the mixing chamber by a distance measured along the axis X2 of at least 1 mm.

This means that the mixing chamber extends beyond the upper opening of the metering output conduit in the direction of increasing X2.

This allows the complete sample to enter the mixing chamber and prevents it from returning to the metering chamber during the metering of a next sample.

Preferably, a volume of the mixing chamber is at least several times a metering volume of the metering chamber, preferably at least three times the metering volume of the metering chamber, such that several liquid samples can be received in the mixing chamber.

In a preferred embodiment, the fluidic unit according to the invention is configured such that the first and second force fields F1, F2 experienced by the fluidic unit result at least in part from modifying a position of the fluidic unit with respect to an external force field, preferably from flipping the fluidic unit in a centrifuge machine. In this way, submitting the fluidic unit to the first and second force fields F1, F2 is eased because centrifuge machines are widespread.

Preferably, the fluidic unit is configured such that the first force field F1 is a first unidirectional force field F1 in a direction of an axis X1 of the fluidic unit.

Preferably, the fluidic unit is configured such that the second force field F2 is a second unidirectional force field F2 in a direction of the axis X2 of the fluidic unit, wherein the direction of the axis X2 is different from the direction of the axis X1.

A smaller angle between the directions of the first and second axes X1, X2 is preferably greater than pi/2 radians, preferably greater than 3*pi/4 radians, preferably equal to pi radians such that the first and second axes have opposite directions. In the latter case, switching from an application of the first unidirectional force field F1 to the second unidirectional force field F2 can be achieved by rotating the fluidic unit by pi radian around an axis orthogonal to the first axis X1. For example, the fluidic unit is flipped upside-down with respect to the source of the first unidirectional force field F1. An example is to flip the fluidic unit upside down in a centrifuge machine. The first and second force fields F1, F2 may have the same of different amplitudes.

Preferably, the direction of the axis X2 is opposed to the direction of the axis X1.

Preferably, the fluidic unit is configured such that the first force field F1 is a first unidirectional force field F1 with an amplitude comprised between 10 and 100000 N/kg, preferably between 70 and 7000 N/kg. Preferably, the force F1 should be sufficient to unlatch a potential capillary valve at the end of the well output conduit. Preferably, it should also be sufficient to avoid capillary imbibition in vented microfluidic channels.

Preferably, the fluidic unit is configured such that the second force field F2 is a second unidirectional force field F2 with an amplitude comprised between 10 and 100000 N/kg, preferably between 70 and 7000 N/kg.

Preferably, the fluidic unit is configured to prevent liquid from passing from the mixing chamber to the metering chamber through the metering output conduit in response to the application of the first force field F1, and preferably also in response to the application of the second force field F2. In this way, accuracy of the metering of the liquid samples is ensured.

Preferably, the fluidic unit is configured to prevent liquid from passing from the metering chamber to the mixing chamber through the metering output conduit in response to the application of the first force field F1. In this way, quantities of the liquid that have not been metered in the metering chamber are prevented from flowing from the metering chamber to the mixing chamber in response to the application of the first force field F1, especially when the waste output conduit is closed by the waste output conduit obstruction means. This ensures accuracy of the volume of each liquid sample brought to the mixing chamber.

Preferably, the fluidic unit is configured for preventing liquid from passing from the well to the metering chamber through the well output conduit in response to the application of the second force field F2. In a preferred embodiment of the fluidic unit comprising the mixing chamber, the metering output conduit has a higher hydraulic conductivity (i.e. less hydraulic resistance) than the well output conduit such that the liquid sample flows preferably through the metering output conduit than through the well output conduit in response to the application of the second force field F2. In this way, the liquid sample is prevented from returning toward the well after being metered, but flows toward the mixing chamber instead.

Preferably, the waste output conduit of the fluidic unit is configured for fluidically connecting to a waste collection container for collecting the excess portion. The waste collection container can be a part of the fluidic unit or a separate element. The waste collection container should have a sufficient volume for collecting one or more excess portions of volumes of liquids depending on the number of liquid samples to be mixed.

Preferably, the fluidic unit is configured such that the liquid is prevented from passing from the metering chamber to the well through the well output conduit in response to the application of the first and/or second force fields F1, F2.

In a preferred embodiment of the fluidic unit comprising the mixing chamber, the mixing chamber extends along the axis X2 and in the direction of increasing X2 from a lower end to an upper end of the mixing chamber, and a shape of the mixing chamber is configured such that:
in response to the application of the first unidirectional force field F1, a liquid sample located in the upper end of the mixing chamber is prevented from leaving the upper end of the mixing chamber by capillary forces, and
upon application of another force in the direction of the axis X1 of the fluidic unit and with an amplitude exceeding an amplitude of the first unidirectional force field F1, the liquid sample located in the upper end of the mixing chamber can flow from the upper end towards the lower end of the mixing chamber.

Such embodiment is very functional in sequential microfluidic networks undergoing centrifugal force.

In an embodiment of the fluidic unit of the invention, the well 3 extends along the axis X2 and in the direction of increasing X2 from a lower part having a conical shape to an upper part having a cylindrical shape. The conical and cylindrical shapes are in contact at an interface. A largest diameter of the cylindrical shape is at the interface between the conical and cylindrical shapes. Preferably, a position of the upper opening of the metering output conduit along the axis X2 and in the direction of increasing X2 is above the interface between the conical and cylindrical shapes. This prevents the liquid from entering the mixing chamber during the metering of the sample when the waste output conduit is obstructed. For example, the upper opening of the metering output conduit may be located at a distance measured along the axis X2 of at least 100 μm, preferably at least 3 mm higher than the interface between the conical and cylindrical shapes.

In an example, the well has a straight section in its upper part and a conical section in its lower part. Preferably, the upper opening of the metering output conduit is located at a distance greater than 0 from the cross-sectional area of the well where the conical section starts, so as to avoid an overflow of liquid to the mixing chamber when the output conduit is closed via the waste output conduit obstruction means. For example, the upper opening of the metering output conduit may be located at a distance of at least 100 μm, preferably at least 3 mm along the axis X2 higher than the cross-sectional area of the well where the conical section starts.

In an embodiment, the fluidic unit comprises a mixing chamber output conduit extending along the axis X2 and in the direction of increasing X2 from a lower opening to an upper opening of the mixing chamber output conduit, wherein the lower opening of the mixing chamber output conduit opens onto the lower surface of the fluidic unit, wherein upper opening of the mixing chamber output conduit opens onto the mixing chamber. Preferably, the upper opening of the mixing chamber output conduit is comprised in the lower end of the mixing chamber. The mixing chamber output conduit may be obstructable. To this end, the waste output obstruction means exposed in the present disclosure in relation to the waste output may be used mutatis mutandis to the obstruction of the mixing chamber output conduit. For example, said lower end mixing chamber is obstructable in a similar manner as the waste output conduit. Thanks to the obstructable mixing chamber output conduit, different samples may be collected in the mixing chamber and mixed together. After mixing, the samples may flow out of the mixing chamber through the opened mixing chamber output conduit and be received in a collection container Said collection container may be the same of different from the waste collection container.

In an example, an alternative collection of the sample from the mixing chamber is through an opening in one end of the mixing chamber, preferably the lower end of the mixing chamber. For example, said lower end mixing chamber is obstructable in a similar manner as the waste output conduit. Thanks to obstruction means, different samples may be collected in the mixing chamber and mixed together. After mixing, it may be possible to open or release said obstruction means and collect the mixed liquid samples in a collection container. Said collection container may be the same of different from the waste collection container.

In an example, the fluidic unit according to the invention comprises a bar comprising a first lateral surface comprising a recessed portion and a sealing member comprising a second lateral surface. The bar and the sealing member are configured such that the fluidic circuit of the fluidic unit is at least partially, and preferably entirely, formed between the recessed portion of the first lateral surface and the second lateral surface when said first and second lateral surfaces are in contact.

The use of the term ‘at least partially’ means that not all of the fluidic circuit is necessarily formed between the recessed portions and the second lateral surface of the sealing member.

According to a second aspect, one of the objects of the present invention is to provide a bar comprising a first lateral surface comprising a recessed portion and configured for contacting a second lateral surface of a sealing member, the bar being configured such that, when said first and second lateral surfaces are in contact, a fluidic unit according to the invention is at least partially (and preferably entirely) formed, the fluidic circuit of said fluidic unit being at least partially (and preferably entirely) formed between the recessed portion of the first lateral surface and the second lateral surface. This provides a convenient way of assembling parts for forming the fluidic unit. The manufacturing of the fluidic units, and especially microfluidic units, is difficult due to the very small dimensions of the fluidic circuit thereof. A convenient way to manufacture such fluidic circuit is to provide the first lateral surface with the recessed portions and to close the recessed portions with a sealing member so as to form the cavities and conduits of the fluidic circuit. Alternatively, the fluidic circuit may be manufactured by additive manufacturing, which enables to produce all elements in one piece. Hence, the bar and the sealing member may be together as one piece. The sealing member is then an external or internal wall of such one piece, having a second lateral surface as described above.

Such a kit comprising the bar and the sealing member can be used for forming a fluidic circuit according to the invention.

In an example, the sealing member is a part of material, preferably of a same material as the bar. In an example, the second lateral surface of the sealing member is substantially flat or planar. In an example, the first lateral surface and the second lateral surface are configured for coupling using solvent bonding.

Preferably, the first lateral surface of the bar comprises a plurality of the recessed portions each corresponding to a respective fluidic circuit. In other words, a fluidic circuit can be at least partially (and preferably entirely) formed between each recessed portion and the second lateral surface of the sealing member. In this case, a plurality of fluidic units according to the invention can be at least partially (and preferably entirely) formed by contacting the first lateral surface of the bar with the second lateral surface of the sealing member, such that the fluidic circuit of each fluidic unit is at least partially (and preferably entirely) formed between a respective recessed portion of the first lateral surface and a corresponding portion of the second lateral surface.

In a preferred embodiment, the bar according to the invention comprises a second lateral surface for contacting the first lateral surface of another bar according to the invention such that one or more fluidic circuits are at least partially (and preferably entirely) formed between the second lateral surface of the bar and the recessed portions of the first lateral surface of the other bar when the second lateral surface of the bar is in contact with the first lateral surface of the other bar.

This means that a bar according to the invention can also be a sealing member to form fluidic circuits in association with another bar. In this case, the bar has a first lateral surface comprising one or more recessed portions and a second lateral surface for contacting with a first lateral surface of another bar and forming fluidic circuits between the recessed portions of the first lateral surface of the other bar and the second lateral surface of the bar. This provides the advantage that several bars can be assembled with the first lateral surface of a first adjacent bar and the second lateral surface of a second adjacent bar in contact to form fluidic units. For example, the adjacent bars could be coupled by solvent bonding.

Preferably, the first lateral surface is configured for contacting a second lateral surface of a sealing member, and the sealing member is a tape, a film, a silicone layer, another bar according to the invention and comprising a second lateral surface, or a part comprising a second lateral surface.

It may be advantageous in certain embodiments, that a first bar according to the invention is spaced apart from a second bar. This may allow sufficient empty space for convection airflow, for example for applications requiring thermal cycles to uniformly warm up materials inside the fluidic circuit. It may further allow for the insertion of sensors (e.g., measurement or optical) between the bars. The construction in bars also offers advantageous modularity. Hence, in particular embodiments, a bar may be moved under an instrument (e.g., microscope), enabling for example real-time observation within the fluidic unit.

According to a third aspect, one of the objects of the present invention is to provide a multi-well plate. The multi-well plate comprises a plurality of the fluidic units according to the invention.

Preferably, the fluidic units of the multi-well plate each comprise a bar comprising the first lateral surface comprising the recessed portion and a sealing member comprising the second lateral surface. The first lateral surface of the bar and the second lateral surface of the sealing member are in contact such that the fluidic circuit of the fluidic unit is at least partially, and preferably entirely, formed between the recessed portion of the first lateral surface and the second lateral surface.

Preferably, the bars of the fluidic units comprised in the multi-well plate are arranged parallel to each other. They may be in contact with each other or spaced apart. The spacing apart allows for inserting testing or heating means in between the fluidic units.

In an embodiment, the multi-well plate comprises a first adjacent bar comprising a first lateral surface, and a second adjacent bar comprising a second lateral surface, wherein the first lateral surface of the first adjacent bar comprises one or more recessed portion and is configured for contacting the second lateral surface of the second adjacent bar when the multi-well plate is assembled, forming one or more fluidic units according to the invention, the fluidic circuit of each fluidic unit being at least partially (and preferably entirely) formed between a corresponding recessed portion of the first lateral surface of the first adjacent bar and the second lateral surface of the second adjacent bar.

In a preferred embodiment, the multi-well plate comprises a third adjacent bar comprising a second lateral surface, and the second adjacent bar comprises a first lateral surface opposed to the second lateral surface of the second adjacent bar. The first lateral surface of the second adjacent bar comprises one or more recessed portions and is configured for contacting the second lateral surface of the third adjacent bar when the multi-well plate is assembled, the second and third adjacent bars being configured such that, when the first lateral surface of the second adjacent bar and the second lateral surface of the third adjacent bar are in contact, one or more fluidic units according to the invention are at least partially (and preferably entirely) formed, the fluidic circuit of each fluidic unit being at least partially (and preferably entirely) formed between a corresponding recessed portion of the first lateral surface of the second adjacent bar and the second lateral surface of the third adjacent bar.

Preferably, the upper surfaces of the fluidic units are comprised in an upper surface of the multi-well plate, and the lower surfaces of the fluidic units are comprised in a lower surface of the well plate.

Preferably, the multi-well plate is configured for using in a centrifuge machine to generate the first and second force fields F1, F2 being centrifugal force fields. Preferably, the centrifuge machine is a swinging-bucket centrifuge.

Preferably, the multi-well plate is an assembly comprising a plurality of bars according to the invention. In an example, each bar comprises the first lateral surface and is coupled to a sealing member to form one or more fluidic units. A plurality of such bars coupled to respective sealing members are assembled to form the multi-well plate.

Preferably, the multi-well plate comprises a first adjacent bar, and a second adjacent bar comprising a second lateral surface. The first lateral surface of the first adjacent bar contacts the second lateral surface of the second adjacent bar so as to form at least one fluidic unit according to the invention. Preferably, the multi-well plate comprises more than two such adjacent bars.

In an example, the multi-well plate according to the invention comprises several fluidic units sharing a same mixing chamber.

According to a fourth aspect, one of the objects of the present invention is to provide a method for trapping a discrete element in a liquid sample in a fluidic unit according to the invention. The method comprises the steps of:
closing the waste output conduit,
inserting a volume of a liquid comprising a discrete element in the well,
while the waste output conduit is closed, applying a first force field F1 on the fluidic unit such that in response to the application of the first force field F1:
   the liquid passes from the well to the metering chamber through the well output conduit,
   the discrete element passes from the well towards the metering chamber through the well output conduit,
opening the waste output conduit,
while the waste output conduit is opened, applying a third force field F3 on the fluidic unit such that in response to the application of the third force field F3:
   the excess portion exits from said metering chamber through the waste output conduit, and
   the liquid sample and the discrete element are prevented from exiting the metering chamber through the waste output conduit.

Some steps of the method may be performed in a different order than that presented above.

The first force field F1 may be a first unidirectional force field F1 in a first direction of an axis X1 of the fluidic unit. The third force field F3 may be a third unidirectional force field F3 directed opposite to the axis X1.

Preferably, the waste output conduit is opened or closed by setting waste output conduit obstruction means of the fluidic unit in an opened or closed configuration.

Preferably, the method comprises, after applying the third force field F3 on the fluidic unit:
applying a second force field F2 in the direction of the axis X2 on the fluidic unit such that, in response to the application of the second force field F2, the liquid sample and the discrete element pass from the metering chamber to the mixing chamber through the metering output conduit.

One of the objects of the present invention is also to provide a method for trapping discrete elements in liquid samples in a multi-well plate according to the invention, and for mixing the plurality of liquid samples in the multi-well plate, the method comprising:
inserting an initial volume of a liquid in the well,
applying a first force field F1 on the multi-well plate and in a direction X1 opposed to the direction X2 of the multi-well plate such that in response to the application of the first force field F1:
   the initial volume of the liquid passes from the well to the metering chamber through the well output conduit,
applying a third force field F3 on the multi-well plate in the direction X1 such that in response to the application of the third force field F3:
   an excess portion of the initial volume of the liquid in excess of the liquid sample exits from the metering chamber through the waste output conduit, and
   the liquid sample is prevented from exiting the metering chamber,
applying a second force field F2 on the multi-well plate in the direction X2 such that in response to the application of the second force field F2:
   the liquid sample passes from the metering chamber to the mixing chamber through the metering output conduit.

Preferably, the steps of the method are repeated N times such that N of the liquid samples are received in the mixing chamber, N being an integer greater than 1.

Preferably, the method comprises, between applying the third force field F3 and the second force field F2:
rotating the multi-well plate by an angle of pi radians around an axis orthogonal to the axis X2.

Preferably, the method comprises, after applying the second force field F2:
rotating the multi-well plate by an angle of pi radians around an axis orthogonal to the axis X2.

According to a fifth aspect, one of the objects of the present invention is to provide a method for manufacturing a fluidic unit according to the invention, the method comprising the steps of:
providing a first part comprising a first lateral surface comprising a recessed portion;
providing a second part comprising a second lateral surface;
contacting the first and second lateral surfaces such that a fluidic circuit of the fluidic unit is at least partially (and preferably entirely) formed between the recessed portion of the first lateral surface and the second lateral surface.

The first, second, and third force field may result from an acceleration of the fluidic device or multi-well plate of the invention. For example, the acceleration field source may be a centrifuge machine. In this case, the acceleration force is applied by rotating the fluidic device or multi-well plate in the centrifuge machine.

In the present application, the use of formulations such as: extending along the axis X1 (or X2), in the direction of increasing X1 (or X2), in the direction of decreasing X1 (X2), for characterizing a feature of the invention does not preclude that such feature may extend along other axes orthogonal to the axes X1 or X2. For example, a conduit or chamber may be characterized as extending along the axis X2 and in the direction of increasing X2, while it also extends along a direction orthogonal to X2.

Similarly, in the present application, the use of similar formulations for characterizing a force field does not preclude that such force field may have other non-zero components orthogonal to the axes X1 or X2, unless specified otherwise. For example, one of the first, second, and third force fields may have non-zero components orthogonal to the axis X2.

### BRIEF DESCRIPTION OF THE FIGURES

These aspects of the invention as well as others will be explained in the detailed description of specified embodiments of the invention, with reference to the drawings in the figures, in which:

FIG. 1 shows a cross-sectional view of an exemplary embodiment of the fluidic unit of the invention, wherein a volume of a liquid comprising a discrete element is received in the well;

FIG. 2 shows a cross-sectional view of the embodiment of the fluidic unit of FIG. 1, wherein liquid can pass from the well to the metering chamber in response to the application of a first force field F1 while the waste output conduit is closed;

FIG. 3 shows a cross-sectional view of the embodiment of the fluidic unit of FIG. 1, wherein an excess portion of the liquid has exited from the metering chamber through the opened waste output conduit in response to the application of the first force field F1;

FIG. 4 shows a cross-sectional view of the embodiment of the fluidic unit of FIG. 1, wherein the liquid sample has passed from the metering chamber to the mixing chamber in response to an application of a second force field F2 opposed to the first force field F1;

FIG. 5 shows a cross-sectional view of an exemplary embodiment of a bar of the invention, the first lateral surface thereof being in contact with a second lateral surface of a sealing member such that several fluidic units according to the invention are formed;

FIG. 6 shows a partially assembled exemplary embodiment of a multi-well plate of the invention and comprising a number of bars according to the invention;

FIG. 7 shows an exemplary embodiment of a multi-well plate of the invention with a waste collection container coupled thereto.

FIG. 8 shows a cross-sectional view an exemplary embodiment of a fluidic unit according to another embodiment of the invention.

FIG. 9 shows a view in perspective of bars according to the second aspect of the invention and stacked on top of each other, with a bar comprising waste collection containers uncoupled.

FIG. 10 shows the bars of FIG. 9 stacked on top of each other and on a bar comprising waste collection containers coupled.

FIG. 11 shows a cross-sectional view of an exemplary embodiment of a multi-well plate of the invention comprising a plurality of fluidic units according to the invention.

The drawings in the figures are not to scale. Generally, similar elements are designated by similar reference signs in the figures. The presence of reference numbers in the drawings is not to be considered limiting, even when such numbers are also included in the claims.

### DETAILED DESCRIPTION OF POSSIBLE EMBODIMENTS OF THE INVENTION

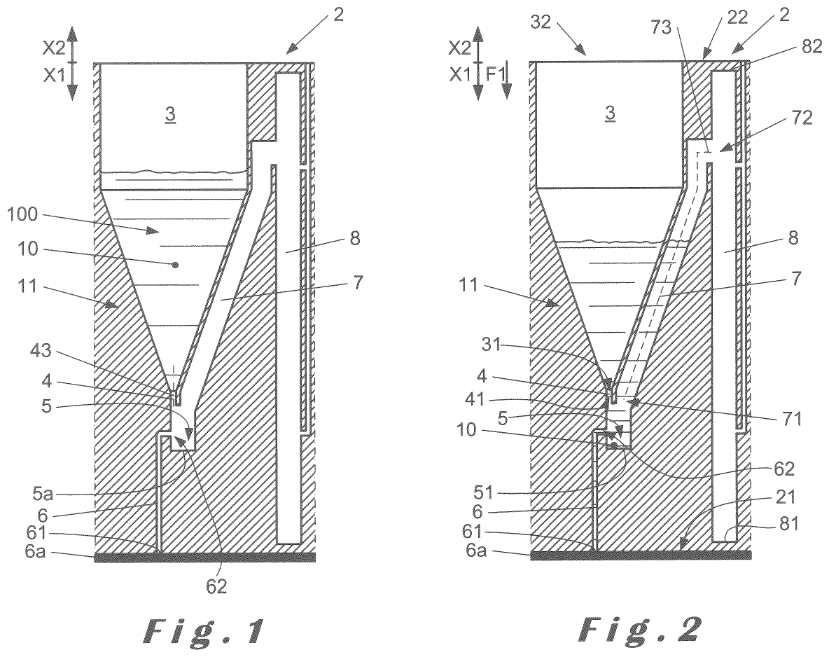

FIG. 1 shows a cross-sectional view of an exemplary embodiment of a fluidic unit according to the invention. The fluidic unit 2 comprises a well 3 for receiving a volume of a liquid 100. The well 3 opens on an upper surface of the fluidic unit 2 such that the volume of the liquid 100 can be deposited or fed therein. Typically, the volume of the liquid 100 is supplied by a pipette. The pipette can be manipulated by a user or moved by a robot. The volume of the liquid 100 supplied to the well can comprise one or more discrete elements 10. The discrete element 10 is preferably a cell or a microparticle, for example a microparticle covered with capture antibodies for immunoassays. Typically, the discrete element 10 has a much smaller volume than the volume of the liquid. In other words, the discrete element is highly diluted in the volume of the liquid.

The liquid 100 is typically an aqueous solution. The fluidic unit 2 is preferably configured for receiving liquid 100 with the following properties:
low or intermediate viscosity, preferably smaller than 100 cS (centistokes);
finite contact angle with the solid surface of the fluidic unit, preferably larger than 45°.
vapor pressure sufficiently high to prevent immediate evaporation.

Dense particle suspensions that would likely jam in the well output conduit 4 (e.g., whole blood) should preferably be avoided.

The device of FIG. 1 also comprises a metering chamber 5 of the overflow type. The metering chamber 5 is configured for separating a portion of the volume of the liquid, herein referred to as the liquid sample 100a, from the rest of the volume of the liquid, herein referred to as the excess portion 100b.

The metering chamber 5 is in fluid communication with the well 3 via a well output conduit 4. In the embodiment of FIG. 1, the well output conduit 4 acts as a capillary valve such that the liquid cannot pass through the well output conduit 4 under the effect of accelerations as low as the gravity force field. Thus, the liquid received in the well 3 can remain in the well under the effect of the gravity force field during manipulation of the fluidic unit 2, but does not flow towards the metering chamber 5 unless a force field of a greater amplitude than gravity drives it through the well output conduit.

The metering chamber in the device of FIG. 1 has a much smaller volume than the well, such that the liquid sample selected out of the volume of the liquid is preferably of a volume less than 1 microliter. This allows to reduce drastically the dilution of a discrete element contained in the liquid sample.

FIG. 2 shows a cross-sectional view of the fluidic unit of FIG. 1, wherein the liquid and discrete element have moved in response to an application of the first unidirectional force field F1 in the direction X1 of the fluidic unit 2. The first force field F1 has an amplitude sufficient for driving the liquid and the discrete element from the well 3 to the metering chamber 5 through the well output conduit 4. In response to the application of the first unidirectional force field F1, the discrete element 10 migrates in the fluidic unit and in the liquid towards the metering chamber. Preferably, the discrete element migrates towards a bottom 51 of the metering chamber 5 being a most extremal part of the metering chamber along the direction X1 of the fluidic unit.

In FIG. 2, the fluidic unit 2 comprises a waste output conduit 6 for evacuating liquid from the metering chamber 5. The waste output conduit 6 is obstructed such that liquid cannot flow in the waste output conduit 6. Obstruction of the waste output conduit 6 is achieved by waste output conduit obstruction means 6a. In FIG. 2, the waste output conduit obstruction means 6a is a tape.

In the embodiment of FIG. 2, the fluidic unit 2 comprises a lower surface opposed to the upper surface of the fluidic unit along the direction X1. The waste output conduit 6 extends up to an aperture in the lower surface 21. This aperture is a lower opening 61 of the waste output conduit 6. The tape in FIG. 2 is installed prior to applying the first unidirectional force field F1 on the fluidic unit. The tape is removably sticking to the lower surface 21 and covers the lower opening 61 of the waste output conduit 6 such that the liquid is prevented from passing therethrough in response to the application of the first unidirectional force field F1. In this case, the waste output obstruction means 6a is in the closed position wherein it prevents liquid from freely flowing through the waste output conduit 6.

In FIG. 2, a very small portion of the liquid has entered the waste output conduit in response to the application of the first unidirectional force field F1. It remains stuck in the waste output conduit due to the waste output conduit obstruction means being in the closed position. Thus, it is prevented from exiting the fluidic unit 2 and to create a flow of the liquid of an amplitude sufficient for carrying the discrete element out of the metering chamber.

The embodiment of the fluidic unit of FIG. 2 further comprises a metering output conduit 7 leading to a mixing chamber 8. In response to the first unidirectional force field F1, the liquid enters the metering output conduit up to a given height. The fluidic unit 2 is configured such that the liquid cannot pass from the metering chamber 5 to the mixing chamber 8 in response to the application of the first unidirectional force F1. In this way, only the liquid sample having controlled volume can be transferred to the mixing chamber. It is important to control the amount of liquid transferred to the mixing chamber correctly, especially when this involves reagents for conducting experiments.

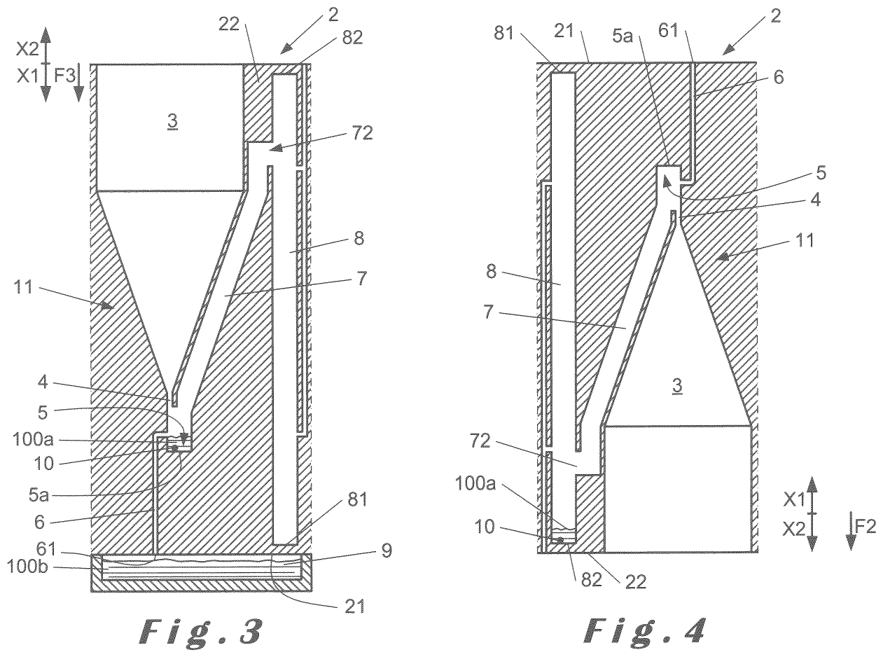

Once the discrete element has migrated to the metering chamber in response to the application of the first unidirectional force F1, the waste output conduit obstruction means 6a can be switched or moved from the closed to the opened configuration as shown in FIG. 3. In this way, the waste output conduit 6 is opened and liquid can pass from the metering chamber through the waste output conduit 6 and exit the fluidic unit 2. In the embodiment of FIG. 3, setting the waste output conduit obstruction means in the opened configuration consists in removing the tape from the lower surface of the fluidic unit.

In the embodiment shown in FIG. 3, a waste collection container 9 is coupled to the fluidic unit. The waste collection container 9 is in fluid communication with the waste output conduit. In this way, the liquid exiting the waste output conduit 6 via the lower opening 61 is collected by the waste collection container 9. In the invention, the waste collection container 9 can be comprised in the fluidic unit or can be a part separate from the fluidic unit 2. In a device comprising a plurality of the fluidic units, each fluidic unit can be fluidically connected to an individual waste collection container 9, or a plurality of fluidic units can be fluidically connected to a common waste collection container.

As shown in FIG. 3, the application of the first unidirectional force F1 on the fluidic unit 2 with the waste output conduit opened causes the excess portion 100b of the liquid to exit the fluidic circuit 11 of the fluidic unit. The excess portion 100b passes from the metering chamber to the waste collection container 9. As a result, no liquid remains in the well 3, in the metering output conduit 7 or in the waste output conduit 6. Only the liquid sample 100a containing the discrete element 10 is retained in the metering chamber 5. In this way, the discrete element 10 is trapped in the metering chamber 5. The discrete element is trapped in the metering chamber with the liquid sample of a predetermined volume. The fluidic unit according to the invention thus allows for reducing and controlling the dilution of the discrete element, even when the volume of the liquid sample is very small. For example, the volume of the liquid sample can be as small as 20 nanoliters. For example, the volume of the metering chamber is of 50 nanoliters.

The embodiment of the fluidic unit shown in FIGS. 1-4 comprises the mixing chamber 8 in fluid communication with the metering chamber through the metering output conduit 7. The mixing chamber is configured for sequentially storing one or more liquid samples. In this way, several liquid samples can be supplied to the mixing chamber to conduct experiments. The volume of each liquid sample is well controlled. The fluidic unit also allows to mix samples of different liquids. Some of the mixed liquid samples can comprise one or more discrete elements whereas other liquid samples can comprise no discrete elements. Also, the liquid samples are supplied sequentially to the mixing chamber. Therefore, the timing for supplying the liquid samples to the mixing chamber is controllable. Furthermore, transferring liquid samples between different devices is a complex task due to the very small volumes of the liquid samples, typically less than 1 microliter. The use of a same fluidic unit for sequentially metering and mixing the liquid samples avoids such transfer of the liquid samples between separated devices.

As shown in FIG. 4, the liquid sample 100a containing the discrete element 10 passes from the metering chamber 5 to the mixing chamber 8 in response to the application of a second unidirectional force field F2. The second unidirectional force field is applied in a second direction X2 of the fluidic unit opposed to the first direction X1.

In the embodiment of FIG. 4, the hydraulic resistance of the well output conduit 4 is greater than the hydraulic resistance of the metering output conduit 7, such that the liquid sample exiting the metering chamber in response to the application of the second unidirectional force field flows towards the mixing chamber 8 and not towards the well 3.

In an alternative embodiment, the invention concerns a fluidic unit configured for trapping a discrete element 10 in a liquid sample 100a. The alternative embodiment comprises a fluidic circuit 11 comprising:
a well 3 for receiving a volume of a liquid 100 comprising the discrete element 10;
a well output conduit 4;
a metering chamber 5 in fluid communication with the well 3 through said well output conduit 4, for metering a liquid sample 100a of the volume of the liquid 100 received from the well 3, the liquid sample 100a preferably having a volume inferior to 1 microliter;
a waste output conduit 6 for evacuating an excess portion 100b of the volume of the liquid 100 from the metering chamber 5;
waste output conduit obstruction means 6a able to be in closed and opened configurations for preventing or allowing the liquid to pass through the waste output conduit 6, respectively.

The alternative embodiment of the fluidic unit 2 is preferably configured such that, in response to an application of a first force field F1:
when the waste output conduit obstruction means 6a is in the closed configuration, the liquid and the discrete element 10 are able to pass from the well 3 to the metering chamber 5 through the well output conduit 4.

The alternative embodiment of the fluidic unit 2 is also preferably configured such that, in response to an application of a third force field F3, and upon switching the waste output conduit obstruction means 6a from the closed to the opened configuration:
the liquid sample 100a and the discrete element 10 are prevented from exiting the metering chamber 5 through the waste output conduit 6, and
the excess portion 100b is able to exit from said metering chamber 5 through the waste output conduit 6.

The third force field F3 can be identical or different from the first force field F1. In an example, said third force field F3 is different in amplitude from the first force field F1. Preferably, the third force field F3 is a unidirectional force field. Preferably, it has the same direction as the first force field F1 but a different amplitude. The first and third force fields F1, F3 can have the same or different directions.

In an embodiment of the fluidic unit comprising a mixing chamber and a metering output conduit, the third force field F3 is different from, and preferably opposed to the second force field F2.

In an example of the fluidic unit according to the invention, the first, second, and third force fields F1, F2, F3 are each unidirectional force fields applied along a first direction X1, a second direction X2, and a third direction X3 of the fluidic unit. Preferably, a smaller angle between the second direction X2 and the third direction X3 is comprised between pi/2 and pi radians, preferably equal to pi radians. Preferably, the first direction X1 is identical to the third direction X3.

Generally speaking, the force field F1 can be constant or varying in time in the fluidic unit and/or method of the invention. Also, the force field F2 can be constant or varying in time in the fluidic unit and/or method of the invention. Also, the force field F3 can be constant or varying in time in the fluidic unit and/or method of the invention.

Generally speaking, the force fields F1 and F2 can differ by their direction and/or amplitude in the fluidic unit and/or method of the invention. Generally speaking, the force fields F2 and F3 can differ by their direction and/or amplitude in the fluidic unit and/or method of the invention. Generally speaking, the force fields F1 and F3 can differ by their direction and/or amplitude in the fluidic unit and/or method of the invention.

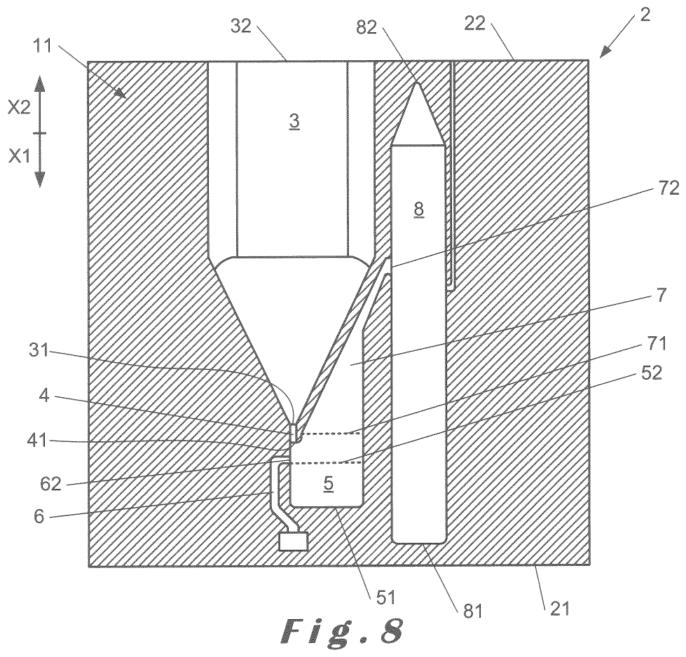

In FIG. 8, another embodiment of the fluidic device 2 according to the invention is shown. The fluidic circuit 11 extends along an axis X2 of the fluidic unit 2 from a lower surface 21 to an upper surface 22 of the fluidic unit. The well 3 of the fluidic circuit 11 extends along the axis X2 and in the direction of increasing X2 from a lower opening 31 to an upper opening 32 of the well 3. The upper opening 32 of the well 3 opens onto the upper surface 22. The well output conduit 4 extends along the axis X2 and in the direction of increasing X2 from a lower opening 41 of the well output conduit 4 to the lower opening 31 of the well 3.

The metering chamber 5 of the fluidic device 2 extends along the axis X2 and in the direction of increasing X2 from a lower end 51 to an upper end 52 of the metering chamber 5, the upper end 52 of the metering chamber 5 being in fluid communication with the well output conduit 4 through the lower opening 41 of the well output conduit 4.

The fluidic device 2 further comprises a waste output conduit 6 extending along the axis X2 and in the direction of increasing X2 from a lower opening 61 to an upper opening 62 of the waste output conduit 6. The upper opening 62 of the waste output conduit 6 is in fluid communication with the metering chamber 5. The upper opening 62 of the waste output conduit 6 is located between the upper end 52 of the metering chamber and the lower opening 41 of the well output conduit 4 along the axis X2. The waste output conduit 6 is openable on the lower surface 21 of the fluidic unit 2 through its lower opening 61.

The fluidic circuit 11 of the fluidic device 2 further comprises a mixing chamber 8 in fluid communication with the metering chamber 5 through a metering output conduit 7. The mixing chamber 8 extends along the axis X2 and in the direction of increasing X2 from a lower end 81 to an upper end 82 of the mixing chamber 8.

The metering output conduit 7 extends along the axis X2 and in the direction of increasing X2 from a lower opening 71 (in fluidic communication with the upper end 52 of the metering chamber 5) to an upper opening 72 of the metering output conduit 7 (in fluid communication with the mixing chamber 8). The lower opening 71 of the metering output conduit 7 is located higher than the lower opening 41 of the well output conduit 4 along the axis X2. The cross-sectional area of the lower opening 71 of the metering output conduit 7 is larger than the cross-sectional area of the lower opening 41 of the well output conduit 4. Preferably, it is 5 times larger.

The upper opening 72 of the metering output conduit 7 is located below the upper end 82 of the mixing chamber 8 along the axis X2. In this way, a number of previously metered liquid samples in the mixing chamber may be forced towards the upper end 82 of the mixing chamber 8 and above the upper opening 72 of the metering output conduit 7 in response to the application of the second force field F2. In this way, subsequent metered liquid samples may enter the mixing chamber. Preferably, a portion of the mixing chamber 8 located beyond the upper opening 72 of the metering output conduit 7 with respect to the axis X2 has a volume comprised between 2 and 20 times the volume of the metering chamber 5.

To prevent the liquid in the mixing chamber 8 from backflowing towards the metering chamber 5 in response to the application of the first force field F1 (e.g. during the metering of a subsequent liquid sample), the upper opening 72 of the metering output conduit 7 is located above the lower end 81 of the mixing chamber 8 along the axis X2. Preferably, a portion of the mixing chamber 8 located below the upper opening 72 of the metering output conduit 7 with respect to the axis X2 has a volume comprised between 2 and 20 times the volume of the metering chamber 5.

The fluidic circuit 2 is configured such that the liquid sample 100a comprising the discrete element 10 is able to pass from said metering chamber 5 to said mixing chamber 8 through the metering output conduit 7 in response to an application of the second force field F2 aligned with the axis X2.

The metering output conduit 7 has a lower hydraulic resistance than the well output conduit 4. This can be achieved in different ways. For example, in FIG. 8, the cross-sectional area of the lower opening 71 of the metering output conduit 7 is greater than the cross-sectional area of the lower opening 41 of the well output conduit 4. For example, in FIG. 8, the cross-sectional area of the metering output conduit 7 substantially decreases from the lower opening 71 to the upper opening 72 of the metering output conduit 7. This prevents the fluid from returning from the metering chamber 5 to the well 3 instead of passing from the metering chamber 5 to the mixing chamber 8 when the second force field F2 is applied on the device.

In FIG. 8, the lower opening 61 of the waste output conduit 6 and the upper opening 32 of the well 3 are located relative to each other such that a projection of the lower opening 61 of the waste output conduit 6 along the axis X2 is entirely comprised in the upper opening 32 of the well 3. In this way, more samples may be produced in a single step by stacking fluidic devices according to the invention on top of each other and with their lower surface 21 facing the upper surface 22 of an adjacent fluidic device 2.

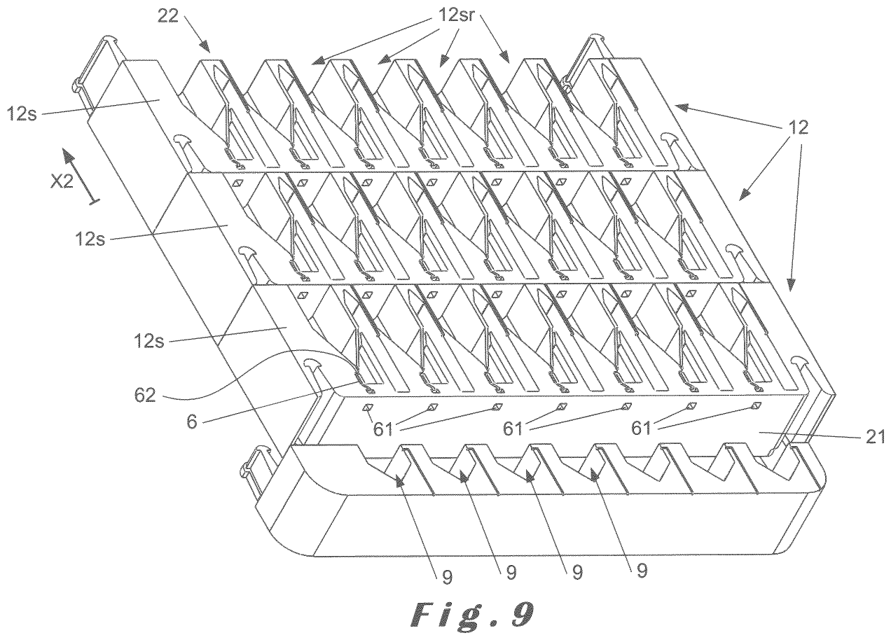

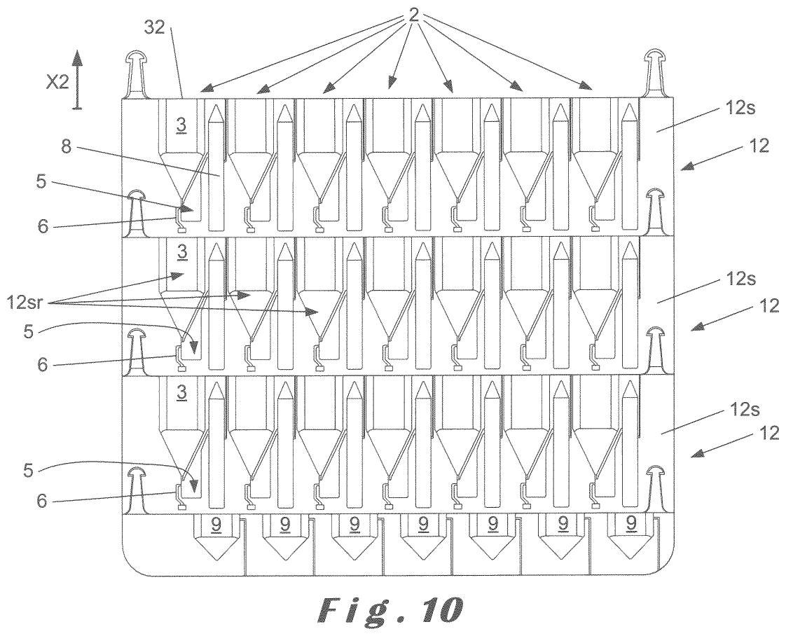

An example of such configuration is shown in FIG. 9. In such an arrangement, the excess portion of the liquid flowing out of an upper fluidic device via its open waste output conduit 6 is received in the well 3 of a lower fluidic device such that another sample may be metered while the first force field F1 is applied on the devices. Two or more of such fluidic devices may be stacked on top of each other to further increase the number of metered samples in a same batch.

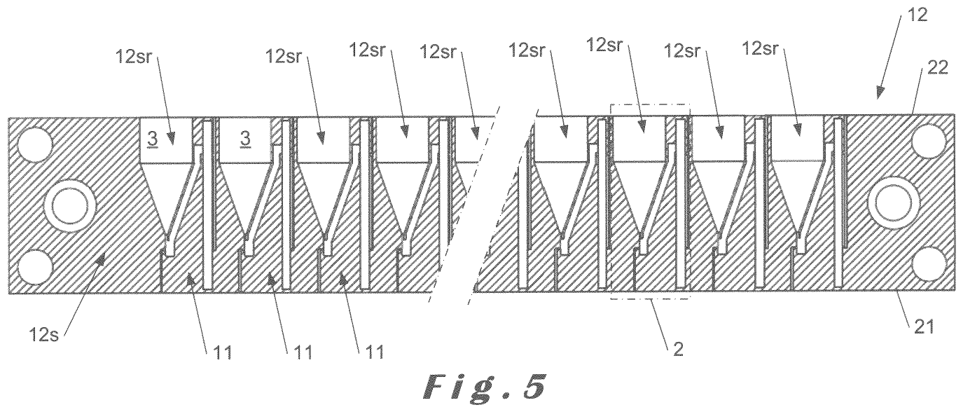

In FIG. 5, a device comprising several fluidic circuits according to the invention is shown. The device is formed by assembling a bar 12 with a sealing member 13 (not shown in FIG. 5). The fluidic circuit 11 of each fluidic unit 2 is formed between a recessed portion 12sr in a first surface 12s of the bar and a second surface belonging to the sealing member 13. The wells of the fluidic circuits open on an upper surface of the bar and the lower openings 61 of the waste output conduits 6 of the fluidic circuits are located on a lower surface of the bar opposed to the upper surface of the bar.

Forming fluidic units according to the invention by using such bar is convenient. Indeed, the recessed portion in the first surface of the bar can be manufactured in a first step. Then, the recessed portions can be closed by the second surface of the sealing member to form the fluidic circuits. In this way, there is no need for drilling through a material to manufacture the fluidic circuit or to use dedicated moulds.

FIGS. 9 and 10 shows an assembly of bars 12 according to the invention. In this assembly, the lower surface 21 of an upper bar is in contact with the upper surface 22 of a lower bar 12. Each bar comprises a first surface 12s comprising recessed portions 12sr for being closed by the second surface of the sealing member to form the fluidic circuits. In this embodiment, the fluidic circuits are only partially formed between the recessed portions 12sr and the second surface of the sealing member 13, see the waste output conduit 6 having its lower opening 61 comprised in the lower surface 21 of the bars.

As shown FIGS. 9 and 10, the lower openings 61 of the waste output conduit 6 are facing the upper openings 32 of the wells 3 when the bars are assembled. In this way, the number of metered samples is multiplied by the number of bars. An excess portion of the liquid flowing out of an upper bar in response to the application of the first or third force field is received in the well 3 of a lower bar. Liquid samples are thus metered successively. The last excess portion exiting from the lowest bar 12 may be received in waste collection container 9 comprised in a dedicated bar. This avoids wasting or dispersing the excess portion of the liquid in a centrifuge machine.

The waste collection container 9 may be configured for receiving liquid from the waste output conduit 6 and/or may be configured for receiving liquid from the mixing chamber, through an opening in the lower end 81 of the mixing chamber 8. The opening in one end of the mixing chamber may be implemented in a similar manner as the waste output conduit. In FIG. 10 for example, the waste collection container 9 is configured so as to receive liquid from the mixing chamber, whereas in FIG. 9, the waste collection 9 is configured so as to receive liquid from the waste output conduit. Both configurations may be present so that both liquids may be collected, depending on the opening or obstructing of the respective conduits.

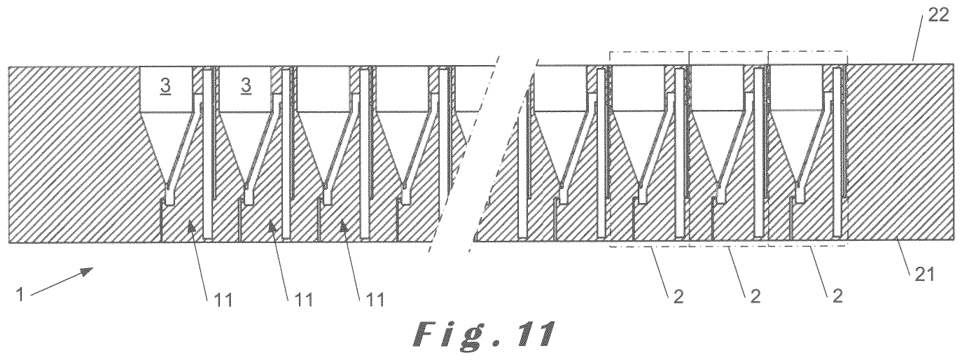

FIG. 11 shows a cross-sectional view of a multi-well plate 1 according to the third aspect of the invention. The multi-well plate 1 comprises several fluidic units 2 according to the invention. The upper surfaces 22 of the fluidic units 2 are comprised in an upper surface of the multi-well plate 1. In this way, all the wells 3 of the fluidic units 2 open on the upper surface of the multi-well plate 1. The lower surfaces 21 of the fluidic units 2 are comprised in the lower surface of the well plate 1. In this way, all the waste output conduits 7 open on the lower surface of the multi-well plate 1.

For example, such multi-well plate 1 may be manufactured through high-precision 3D-printing techniques.

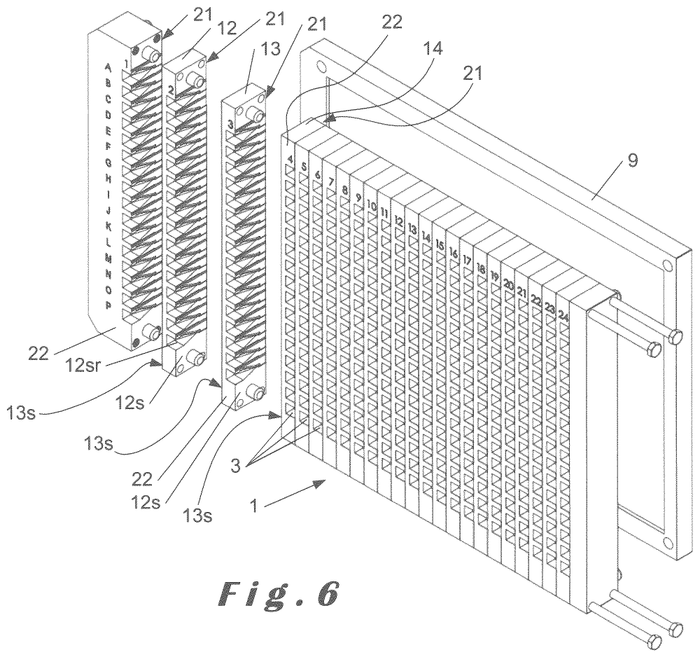

FIG. 6 shows a multi-well plate 1 comprising an assembly of several bars according to a preferred embodiment of the invention. Some bars 12 of the multi-well plate 1 not only comprise the first lateral surface 12s with the recessed portions 12sr, but also a second lateral surface 13s configured for contacting or mating with the first lateral surface 12s of an adjacent bar to form fluidic units and circuits according to the invention, as explained below.

In FIG. 6, the multi-well plate 1 comprises a first adjacent bar 12 and a second adjacent bar 13. The first adjacent bar 12 comprises a first lateral surface 12s comprising one or more recessed portion 12sr. The second adjacent bar 13 comprises a second lateral surface 13s. When the first and second bars are assembled to form the multi-well plate 1, the first lateral surface 12s of the first adjacent bar 12 is pressed against the second lateral surface 13s of the second adjacent bar 13. The first and second lateral surfaces 12s, 13s are in sealing contact except at a level of the recessed portions 12sr, such that one or more fluidic circuits 11 are formed between the recessed portion 12sr and the second lateral surface 13s.

To reduce the number of bars required to assemble the multi-well plate 1, both lateral surfaces of the bars may be used to form fluidic circuits 11.

For example, as illustrated in FIG. 6, the multi-well plate 1 comprises a third adjacent bar 14 having a second lateral surface 13s, and the second adjacent bar 13 comprises a first lateral surface 12s opposed to its second lateral surface 13s. The first lateral surface 12s of the second adjacent bar 13 comprises one or more recessed portions 12sr and is pressed against the second lateral surface 13s of the third adjacent bar 14 when the multi-well plate 1 is assembled. In this way, fluidic circuits 11 are formed between the recessed portions 12sr of the first lateral surface 12s of the second adjacent bar 13 and the second lateral surface 13s of the third adjacent bar 14.

In the embodiment of FIG. 6, the second lateral surfaces 13s of the bars 12 are planar. The multi-well plate shown in FIG. 6 is not fully assembled.

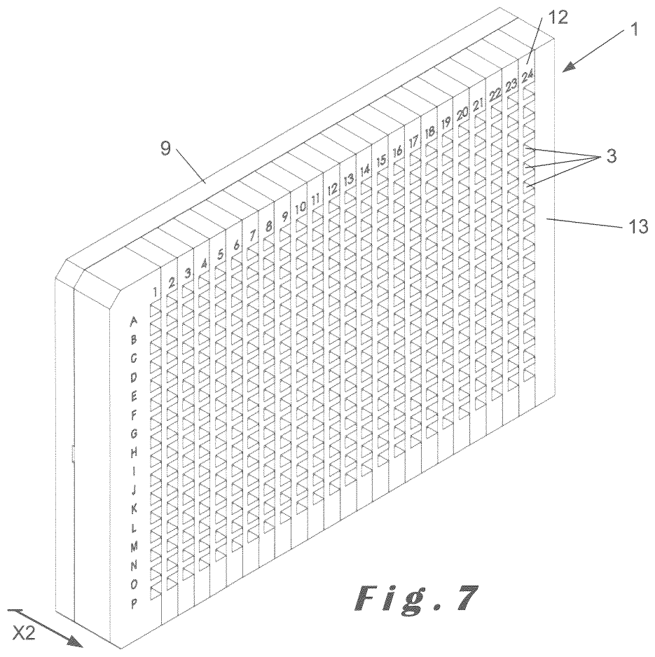

In FIG. 7, the multi-well plate 1 of FIG. 6 is represented fully assembled. It comprises 24 adjacent bars 12. All the wells 3 of the fluidic circuits open on an upper surface of the multi-well plate. A waste collection container 9 is coupled to a lower surface of the multi-well plate opposed to the upper surface thereof.

The multi-well plate 1 of FIGS. 6 and 7 is configured for installing in a centrifuge machine for applying the first and second force fields F1, F2 to the multi-well plate, and driving liquids in the fluidic circuits.

The present invention has been described with reference to specific embodiments, the purpose of which is purely illustrative, and they are not to be considered limiting in any way. In general, the present invention is not limited to the examples illustrated and/or described in the preceding text. Use of the verbs “comprise”, “include”, “consist of”, or any other variation thereof, including the conjugated forms thereof, shall not be construed in any way to exclude the presence of elements other than those stated. Use of the indefinite article, “a” or “an”, or the definite article “the” to introduce an element does not preclude the presence of a plurality of such elements. The reference numbers cited in the claims are not limiting of the scope thereof.

In summary, the invention may also be described as follows. A fluidic unit 2, preferably microfluidic, for trapping a discrete element 10 in a liquid sample 100a and comprising:
a well 3 for receiving a volume of a liquid 100 comprising the discrete element 10;
a well output conduit 4;
a metering chamber 5 in fluid communication with the well 3 through said well output conduit 4, for metering a liquid sample 100a of the volume of the liquid 100 received from the well 3;
a waste output conduit 6 for evacuating an excess portion 100b of the volume of the liquid 100 from the metering chamber 5.

An exemplary method for trapping a discrete element 10 in a liquid sample 100 using the fluidic unit 2 of the invention is detailed below.

The method comprises a first step of setting the waste output obstruction means 6a of the fluidic unit in a closed configuration such that liquid 100 is prevented from flowing in the waste output conduit 6. In a second step, the well 3 is supplied with a volume of a liquid 100 comprising a discrete element 10. In a third step, the fluidic unit 2 is placed in a centrifuge machine. In a fourth step, the waste output conduit 6 is kept closed and a first force field F1 is applied on the fluidic unit 2. The first force field F1 is applied along a first direction X1 of the fluidic unit. The first force field F1 is a centrifugal force field because it is generated by a centrifuge machine, but it is substantially unidirectional across the fluidic unit 2. In response to the application of the first force field F1, the liquid and the discrete element pass from the well 3 to the metering chamber 5 via the well output conduit 4.

Following the application of the first force field F1, the discrete element migrates towards a bottom of the metering chamber. The bottom of the metering chamber is an extremal and downstream portion of the metering chamber 5 along the direction X1. In this way, the application of the first force field F1 along the direction X1 drives the discrete element with a higher mass density than the liquid towards the bottom of the metering chamber.

Once the discrete element 10 has reached the metering chamber 5, a fifth step comprises switching the waste output obstruction means 6a from the closed to the opened position. In a sixth step, while the waste output conduit is opened, a third force field F3 is applied on the fluidic unit 2. In response to the application of the third force field F3, an excess portion 100b of the liquid 100 flows from the metering chamber 5 to the waste collection container via the opened waste output conduit 6. The third force field F3 may be different or identical to the first force field F1. In the present exemplary embodiment of the method, the third force field F3 is a centrifugal force field being substantially unidirectional across the fluidic unit. The third force field F3 is directed along the same direction as the first force field F1 but is of greater amplitude.

Due to the shape of the fluidic unit 2 and the direction of the third force field F3, the liquid sample and the discrete element are prevented from exiting the metering chamber through the waste output conduit. They are trapped in the metering chamber.

In summary, the method comprises the steps of:
closing the waste output conduit,
inserting a volume of a liquid in the well, the volume of the liquid preferably comprising a discrete element,
while the waste output conduit is closed, applying a first force field F1 on the fluidic unit such that in response to the application of the first force field F1:
   the liquid and the discrete element pass from the well to the metering chamber through the well output conduit,
opening the waste output conduit,
while the waste output conduit is opened, applying a third force field F3 on the fluidic unit such that in response to the application of the third force field F3:
   the excess portion exits from said metering chamber through the waste output conduit, and
the liquid sample and the discrete element are prevented from exiting the metering chamber through the waste output conduit.

As already exposed, the third force field F3 can be identical or different from the first force field F1. In an example, said third force field F3 is different in amplitude from the first force field F1. Preferably, the third force field F3 is a unidirectional force field. Preferably, it has the same direction as the first force field F1. In an embodiment of the fluidic unit comprising a mixing chamber and a metering output conduit, the third force field F3 is different from, and preferably opposed to the second force field F2.

Preferably, the method further comprises a seventh step of detaching and removing the waste collection container containing the excess portion of the liquid from the fluidic unit.

Preferably, the method further comprises an eighth step of applying a second force field F2 on the fluidic unit, the second force field F2 being a second unidirectional force field in a second direction X2 of the fluidic unit opposed to the first direction X1. In response to the application of the second unidirectional force field, the metered liquid sample and the discrete element contained therein pass from the metering chamber to the mixing chamber through the waste output conduit. Following this, the liquid sample and discrete element can be collected in the mixing chamber, or steps of the method can be repeated to supply additional liquid samples to the mixing chamber. In this way, the liquid sample and discrete element can be mixed with the additional liquid samples preferably comprising additional discrete elements or additional reagents for experimentations.

In an experiment, the inventors proved that the liquid flow inside the mixing chamber can be controlled during the metering step in terms of acceleration threshold for driving the liquid in the mixing chamber. In the experiment, 5 μl of liquid are supplied in the well while a previous liquid sample is already in the mixing chamber, in a most elevated portion of the mixing chamber with respect to the direction X1 of the first force field F1. Then, the first force field F1 is applied to the fluidic unit. In response to the application of the first force field F1, the liquid in the well flows from the well to the metering chamber but the previous liquid sample in the mixing chamber does not experience any flow. This is due to the given geometry of the mixing chamber which sets the necessary acceleration threshold for moving the previous liquid sample higher than the acceleration required to perform the metering. In response to an application of an acceleration higher than the necessary acceleration threshold and in the direction X1, the previous liquid sample passes from the most elevated portion of the mixing chamber to the least elevated portion of the mixing chamber with respect to the direction X1. In other words, the acceleration required for moving the liquid from one end to the opposed end of the mixing chamber is greater than the acceleration required for the metering of a liquid sample. This can be very functional in sequential microfluidic networks undergoing centrifugal force.

In an experiment, the inventors trapped a particle with an exemplary embodiment of the fluidic unit of the invention. In this aim, polystyrene particles with a diameter of 5.21 μm were diluted in deionized water. Then, the lower opening 61 of the waste output conduit 6 was obstructed with a suitable paste and the liquid was pressurized towards the metering chamber by centrifugation. The polystyrene particles migrated towards the metering chamber. After opening the lower opening 61, the excess portion of the liquid was then driven out of the fluidic unit by centrifugation, while the liquid sample containing the polystyrene particles remained trapped in the metering chamber. This experiment was repeated three times successfully.

The present application also discloses a method for trapping discrete elements 10 in liquid samples 100a by using a multi-well plate 1 according to the invention. The method also allows for mixing the plurality of liquid samples 100a in the multi-well plate 1. First, initial volumes of one or more liquids are inserted in the wells 3 of the multi-well plate 1. Optionally, the multi-well plate 1 may be stacked on top of one or more other multi-well plates 1 according to the invention, as explained above, to increase the number of metered samples as explained above. Then, the multi-well plate 1 is inserted in a swinging bucket centrifuge machine with its lower surface oriented towards and supported by the bucket. The rotating speed of the centrifuge is then increased up to reaching a speed such that a first force field F1 is applied on the multi-well plate 1 and in a direction X1 opposed to the direction X2 of the multi-well plate 1.

In response to the application of the first force field F1, the liquid 100 passes from the wells 3 to the metering chambers 5. Then, a third force field F3 is applied on the multi-well plate 1 in the direction X1 such that the portions 100b of the liquid in excess of the liquid sample 100a exit from the metering chambers 5 through the waste output conduit 6, whereas the liquid samples 100a are prevented from exiting the metering chambers 5. In case multiple multi-well plates 1 are stacked onto each other such that the lower openings 61 of the waste output conduits 6 of an upper multi-well plate are facing the upper openings of the wells 3 of a lower multi-well plate, the metering occurs in each of the stacked multi-well plates while the third force field is continuously applied on the plates.

After the metering operation, the centrifuge is switched off and the multi-well plate (or the stacked multi-well plates) are flipped upside down in the machine such that the upper surface of the multi-well plate 1 is supported by, and facing the bucket. Then, a second force field F2 is applied on the multi-well plate or plates 1 in the direction X2 such that the liquid samples 100a pass from the metering chambers 5 to the mixing chambers 8.

The steps of this method may be repeated several times with the same or different liquids such that several samples are mixed in the mixing chambers of the multi-well plates. For metering and driving N samples in each mixing chambers of the plate according to the invention, the plate needs to be flipped 2N-1 times with respect to the centrifuge machine.

1. A fluidic unit for trapping a discrete element in a liquid sample having a volume less than 1 microliter and comprising a fluidic circuit comprising:
a well for receiving a volume of a liquid comprising the discrete element;
a well output conduit;
a metering chamber in fluid communication with the well through said well output conduit, for metering a liquid sample of the volume of the liquid received from the well; and
an obstructable waste output conduit for evacuating an excess portion of the volume of the liquid from the metering chamber,
wherein the fluidic unit extends along an axis X2 and in the direction of increasing X2 from a lower surface to an upper surface of the fluidic unit;
wherein the well opens on the upper surface of the fluidic unit through the upper opening of the well; and
wherein the waste output conduit is openable on the lower surface of the fluidic unit through the lower opening of the waste output conduit.

2. The fluidic unit according to claim 1, wherein:
the fluidic circuit extends along an axis X2 of the fluidic unit;
the well extends along the axis X2 and in the direction of increasing X2 from a lower opening to an upper opening of the well;
the well output conduit extends along the axis X2 and in the direction of increasing X2 from a lower opening of the well output conduit to the lower opening of the well;
the metering chamber extends along the axis X2 and in the direction of increasing X2 from a lower end to an upper end of the metering chamber, the upper end of the metering chamber being in fluid communication with the well output conduit through the lower opening of the well output conduit; and
the waste output conduit extends along the axis X2 and in the direction of increasing X2 from a lower opening to an upper opening of the waste output conduit in fluid communication with the metering chamber, the upper opening of the waste output conduit being located between the upper end of the metering chamber and the lower opening of the well output conduit along the axis X2.

3. The fluidic unit according to claim 2, comprising a metering output conduit extending along the axis X2 and in the direction of increasing X2 from a lower opening of the metering output conduit in fluidic communication with the upper end of the metering chamber to an upper opening of the metering output conduit,
wherein the lower opening of the metering output conduit is located higher than the lower opening of the well output conduit along the axis X2; and
wherein the lower opening of the metering output conduit is separated from the lower opening of the well output conduit by a distance measured along the axis X2 greater than Oum or of at least 1 μm.

4. (canceled)

5. The fluidic unit according to claim 3, having:
a cross-sectional area of the metering output conduit measured in a plane normal to a longitudinal axis of the metering output conduit; and
a cross-sectional area of the well output conduit measured in a plane normal to a longitudinal axis of the well output conduit,
and wherein the cross-sectional area of the metering output conduit at its lower opening is greater than the cross-sectional area of the well output conduit at the lower opening of the well output conduit.

6. (canceled)

7. The fluidic unit according to claim 3, wherein the cross-sectional area of the metering output conduit substantially decreases from the lower opening to the upper opening of the metering output conduit.

8-9. (canceled)

10. The fluidic unit according to claim 1, wherein the fluidic circuit comprises waste output conduit obstruction means able to be in closed and opened configurations for preventing or allowing the liquid to pass through the waste output conduit, respectively,
wherein the waste output conduit obstruction means is selected among:
a valve for closing and opening the waste output conduit;
a tape for removably sticking to the lower surface of the fluidic unit to obstruct the lower opening of the waste output conduit;
a plug for removably obstructing the lower opening of the waste output conduit; or
a dead-end of the waste output conduit, and the waste output conduit openable by piercing or drilling the fluidic unit through the dead-end; or
a dissolvable membrane for obstructing the lower opening of the waste output conduit and for dissolving upon an application of a solvent on it.

11. The fluidic unit according to claim 10, and wherein the fluidic unit is configured such that, in response to an application of a first unidirectional force field F1 in a direction of an axis X1 opposed to the direction of the axis X2 of the fluidic unit:
when the waste output conduit obstruction means is in the closed configuration:
the liquid and the discrete element are able to pass from the well to the metering chamber through the well output conduit;
upon switching the waste output conduit obstruction means from the closed to the opened configuration:
the liquid sample and the discrete element are prevented from exiting the metering chamber through the waste output conduit, and
the excess portion is able to exit from said metering chamber through the waste output conduit.

12. (canceled)

13. The fluidic unit according to claim 3, wherein the fluidic circuit further comprises a mixing chamber in fluid communication with the metering chamber through said metering output conduit, for mixing several liquid samples coming from the metering chamber.

14. The fluidic unit according to claim 13, wherein:
the mixing chamber extends along the axis X2 and in the direction of increasing X2 from a lower end to an upper end of the mixing chamber;
the metering output conduit is in fluidic communication with the mixing chamber through the upper opening of the metering output conduit;
the upper opening of the metering output conduit is located below the upper end of the mixing chamber along the axis X2; and
the upper opening of the metering output conduit is located above the lower end of the mixing chamber along the axis X2, least 1 mm.

15. The fluidic unit according to claim 13, configured such that the liquid sample comprising the discrete element is able to pass from said metering chamber to said mixing chamber through the metering output conduit in response to an application of a second unidirectional force field F2 in a direction of the axis X2 of the fluidic unit.

16-17. (canceled)

18. The fluidic unit according to claim 13, wherein the mixing chamber extends along the axis X2 and in the direction of increasing X2 from a lower end to an upper end of the mixing chamber, and wherein a shape of the mixing chamber is configured such that:
in response to the application of the first unidirectional force field F1, a liquid sample located in the upper end of the mixing chamber is prevented from leaving the upper end of the mixing chamber by capillary forces; and
upon application of another force in the direction of the axis X1 of the fluidic unit and with an amplitude exceeding an amplitude of the first unidirectional force field F1, the liquid sample located in the upper end of the mixing chamber can flow from the upper end towards the lower end of the mixing chamber.

19. (canceled)

20. A bar comprising a first lateral surface comprising a recessed portion and configured for contacting a second lateral surface of a sealing member, the bar being configured such that, when said first and second lateral surfaces are in contact, the fluidic unit according to claim 1 is at least partially formed, the fluidic circuit of said fluidic unit being at least partially formed between the recessed portion of the first lateral surface and the second lateral surface.

21. The bar according to claim 20, wherein the first lateral surface comprises a plurality of the recessed portions each corresponding to a respective fluidic circuit.

22. The bar according to claim 20, further comprising a second lateral surface for contacting the first lateral surface of another bar according to claim 20 such that one or more fluidic circuits are at least partially formed between the second lateral surface of the bar and the recessed portions of the first lateral surface of the other bar when the second lateral surface of the bar is in contact with the first lateral surface of the other bar.

23. The bar according to claim 20, wherein the first lateral surface is configured for contacting a second lateral surface of a sealing member, the sealing member being a tape, a silicone layer, a second bar, or a part comprising a second lateral surface.

24. A multi-well plate comprising a plurality of fluidic units according to claim 1.

25. A multi-well plate comprising a first adjacent bar comprising a first lateral surface, and a second adjacent bar comprising a second lateral surface, wherein the first lateral surface of the first adjacent bar comprises one or more recessed portion and is configured for contacting the second lateral surface f the second adjacent bar when the multi-well plate is assembled, forming one or more fluidic units according to claim 1, the fluidic circuit of each fluidic unit being at least partially formed between a corresponding recessed portion of the first lateral surface of the first adjacent bar and the second lateral surface of the second adjacent bar.

26. The multi-well plate according to claim 25, comprising a third adjacent bar comprising a second lateral surface,
wherein the second adjacent bar comprises a first lateral surface opposed to the second lateral surface of the second adjacent bar; and
wherein the first lateral surface of the second adjacent bar comprises one or more recessed portions and is configured for contacting the second lateral surface of the third adjacent bar when the multi-well plate is assembled, the second and third adjacent bars being configured such that, when the first lateral surface of the second adjacent bar and the second lateral surface of the third adjacent bar are in contact, one or more fluidic units are at least partially formed,
wherein the one or more fluidic units each include a fluidic circuit comprises:
a well for receiving a volume of a liquid comprising the discrete element;
a well output conduit;
a metering chamber in fluid communication with the well through said well output conduit, for metering a liquid sample of the volume of the liquid received from the well; and
an obstructable waste output conduit for evacuating an excess portion of the volume of the liquid from the metering chamber,
wherein the fluidic unit extends along an axis X2 and in the direction of increasing X2 from a lower surface to an upper surface of the fluidic unit;
wherein the well opens on the upper surface of the fluidic unit through the upper opening of the well;
wherein the waste output conduit is openable on the lower surface of the fluidic unit through the lower opening of the waste output conduit, and
wherein the fluidic circuit of each fluidic unit is at least partially formed between a corresponding recessed portion of the first lateral surface of the second adjacent bar and the second lateral surface of the third adjacent bar.

27. The multi-well plate according to claim 24, wherein the upper surfaces of the fluidic units are comprised in an upper surface of the multi-well plate, and the lower surfaces of the fluidic units are comprised in a lower surface of the well plate.

28-34. (canceled)

35. A multi-well plate according to claim 25, wherein the upper surfaces of the fluidic units are comprised in an upper surface of the multi-well plate, and the lower surfaces of the fluidic units are comprised in a lower surface of the well plate.
